(19) United States
(12) Patent Application Publication
(10) Pub. No.: US 2008/0201519 A1
(43) Pub. Date: Aug. 21, 2008

(54) MEMORY CARD

(75) Inventors: Jin-Young JUNG, Chungcheongnam-do (KR); Gwang-Man LIM, Seoul (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/938,432

(22) Filed: Nov. 12, 2007

(30) Foreign Application Priority Data
Feb. 16, 2007 (KR) 2007-0016801

(51) Int. Cl. G06F 12/02; G06F 12/00

(52) U.S. Cl. 711/103; 711/102; 711/115; 711/E12.008; 711/E12.005

(57) ABSTRACT

A memory card is structured to support a variety of applications by dividing a storage region into a plurality of sub storage regions, each sub storage region being assigned a particular data format associated with each of a plurality of application programs stored in a controller of the memory card. The data stored in each of the sub storage regions co-exists compatibly in the memory card. This allows for a multiplicity of applications, which can be made available through the use of a single memory card.

### CROSS-REFERENCE TO RELATED PATENT APPLICATION

This application claims the benefit of Korean Patent Application No. 10-2007-0016801, filed on Feb. 16, 2007, in the Korean Intellectual Property Office, the disclosure of which is incorporated herein in its entirety by reference.

### BACKGROUND OF THE INVENTION

1. Field of the Invention

The present invention relates to a memory card, and more particularly, to a memory card which can be used for a variety of application products.

2. Description of the Related Art

FIGS. 1 and 2 illustrate the internal construction of a conventional memory card. Referring to FIGS. 1 and 2, a memory card 3 includes a controller 1 and a memory 2. An external host device 4, which is connected to the memory card 3, issues a memory card command based on a multimedia card's protocol specification, thus reading file data from the memory card 3 or writing file data to the memory card 3. The host device 4 may be a cellular phone, a Personal Digital Assistant (PDA), a personal computer, a music reproducing apparatus, a digital camera, a video camera, among other possibilities. For example, referring to FIG. 1, when the memory card 3 is connected to a host device 4, where the host device 4 is a digital camera, the controller 1 uses an application program A. Here, the application program A is stored in a ROM 1a of the controller 1. The application program A may be a firmware program for performing folder management and data format management so that data A′ regarding the application program A can be stored in the memory 2 in the format of the data A′. That is, in order to store the data A′ regarding the application program A in the memory 2, all of the memory regions of the memory 2 are assigned in the format of the data A′ by the controller 1. Once the memory regions are assigned in the format of the data A′, the data A′ is stored in a predetermined region 2a of the memory 2. The remaining region 2a′, excluding the predetermined region 2a in which the data A′ is stored, contains no data.

Referring to FIG. 2, when the memory card 3 is connected to a host device 4, where the host device 4 is a cellular phone, the controller 1 uses an application program B. Likewise, the application program B is stored in a ROM 1b of the controller 1. The application program B may be a firmware program for performing folder management and data format management so that data B′ regarding the application program B can be stored in the memory 2 in the format of the data B′. That is, in order to store the data B′ regarding the application program B in the memory 2, all of the memory regions of the memory 2 are assigned in the format of the data B′ by the controller 1. Once the memory regions are assigned in the format of the data B′, the data B′ is stored in a predetermined region 2b of the memory 2. Accordingly, the previously stored data A′ regarding the application program A is deleted, and the data B′ is stored in the predetermined region 2b of the memory 2. The remaining region 2b′, excluding the predetermined region 2b in which the data B′ is stored, contains no data. That is, if an application program is changed when a memory card is connected to a host device, a memory of the memory card must be assigned in the format of data regarding the corresponding application program. Accordingly, data corresponding to a variety of application programs cannot be stored together in the memory. For this reason, a need remains for a memory card that can store data regarding different application programs, which correspond to a variety of host devices without deleting previously stored data.

### SUMMARY OF THE INVENTION

The present invention provides a memory card, which can be connected to a different host device and store data associated with a different application program, without missing or losing previously stored data.

One example embodiment of the present invention includes: a controller structured to store at least one application program; and a memory having a storage region structured to store data associated with the at least one application program, wherein the controller is configured to divide the storage region into a plurality of sub storage regions, each of the sub storage regions being associated with data from one of the application programs.

Another example embodiment of the present invention includes: a controller structured to store a plurality of application programs including a first application program and a second application program; and a memory having a storage region structured to store first data associated with the first application program and second data associated with the second application program, wherein the first application program is configured to assign a first region in the format of the first data, the first region comprising at least one part of the storage region, and wherein the second application program is configured to assign a second region in the format of the second data, the second region comprising at least one part of the first region or at least one part of the remaining region excluding the first region.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 illustrate the internal construction of a conventional memory card; and

FIGS. 3 through 6 illustrate the internal construction of a memory card according to an embodiment of the present invention.

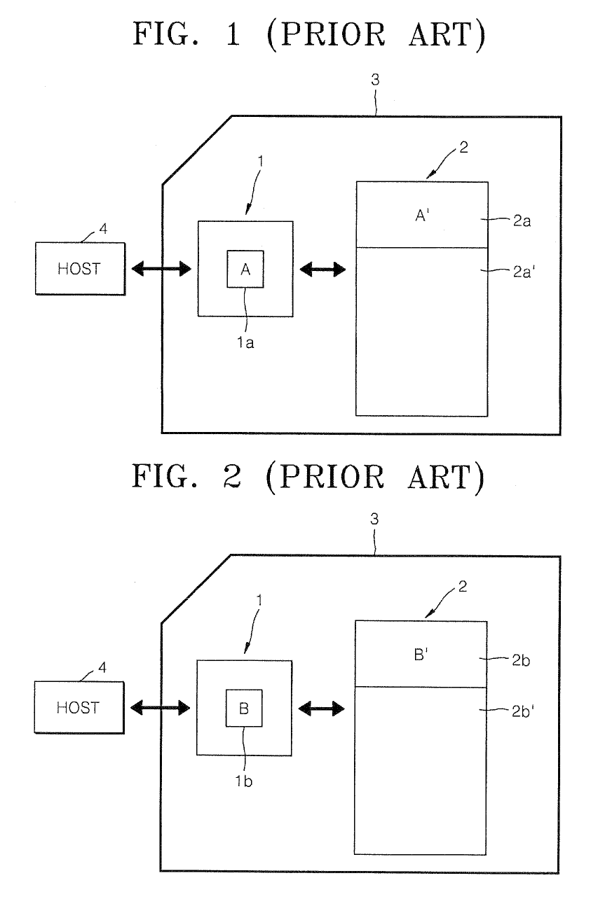

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

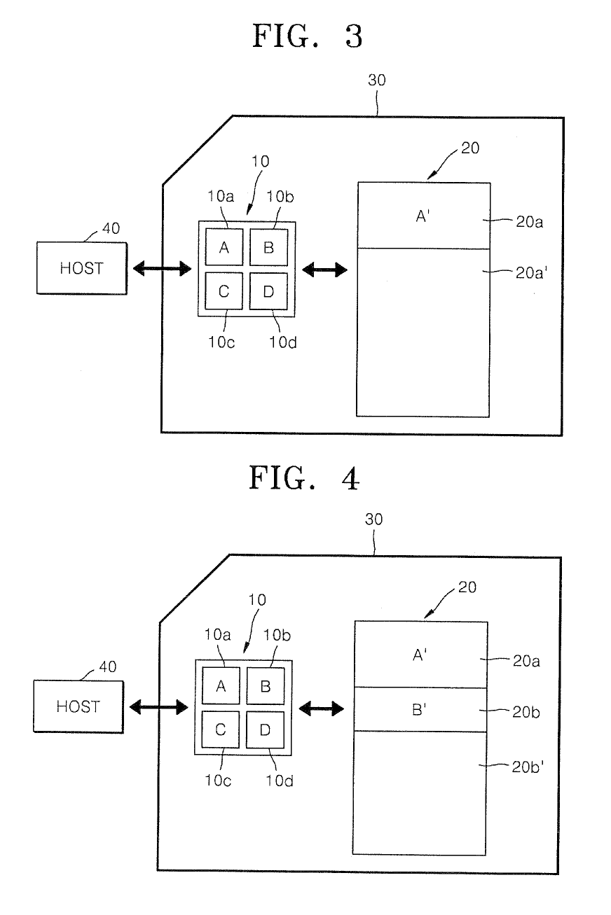

FIGS. 3 through 6 illustrate the internal construction of a memory card 30 according to an embodiment of the present invention.

Referring to FIG. 3, the memory card 30 may include a controller 10 and a memory 20. An external host device 40, which may be connected to the memory card 30, can issue a memory card command based on a multimedia card's protocol specification. In this manner, external host device 40 may read file data from the memory card 3 or write file data to the memory card 3. The host device 40 may be a cellular phone, a Personal Digital Assistant (PDA), a personal computer, a music producing device, a digital camera, a video camera, among other possibilities. The controller 10 stores application programs associated with a variety of host devices 40. For example, when the memory card 30 is connected to a host device 40, where the host device 40 is a digital camera manufactured by a first company, an application program A is needed. Also, when the memory card 30 is connected to a host device 40, where the host device 40 is a digital camera manufactured by a second company, an application program B is needed. Similarly, when the memory card 30 is connected to a host device 40, where the host device 40 is a cellular phone manufactured by a third company, an application program C is needed. Furthermore, when the memory card 30 is connected to a host device 40, where the host device 40 is a music reproducing apparatus manufactured by a fourth company, an application program D is needed. That is, the controller 10 of the memory card 30 can store one or more application programs. In this example embodiment, the controller 10 includes ROMs 10a, 10b, 10c, and 10d, which store the application programs A, B. C, and D, respectively. As illustrated in FIGS. 3 through 6, the ROMs 10a, 10b, 10c, and 10d corresponding to the application programs A, B, C, and D are installed in the controller 10. A person with skill in the art will recognize that more or less than four application programs can be stored in a single ROM. Also, at least one application program may include a firmware program regarding a data management method, a data folder management method, or a data format management method of the corresponding application product. Meanwhile, the controller 10 can read IDs of a variety of application products.

In FIG. 3, a host device 40 may be a digital camera manufactured by a first company and can be connected to the memory card 30. The controller 10 may store a first application program A. The memory 20 may have a storage region, which can store first data A′ associated with the first application program A. For example, the first data A′ may include file data of pictures that are picked up by the digital camera manufactured by the first company. The first application program A may include a program for assigning a first region 20a, which is at least one part of the storage region, in the format of the first data A′. The first data A′ may then be stored in the first region 20a.

Referring to FIG. 4, a host device 40 may be a digital camera manufactured by a second company and can be connected to the memory card 30. The controller 10 may store a second application program B. The memory 20 may have a storage region, which can store second data B′ associated with the second application program B. For example, the second data B′ may include file data of pictures that are picked up by the digital camera manufactured by the second company. The second application program B may include a program for assigning a second region 20b, which is at least one part of the remaining region (20a′ of FIG. 3) excluding the first region 20a of the storage region, in the format of the second data B′. The second data B′ may then be stored in the second region 20b. The format of the second data B′ may be different from the format of the first data A′.

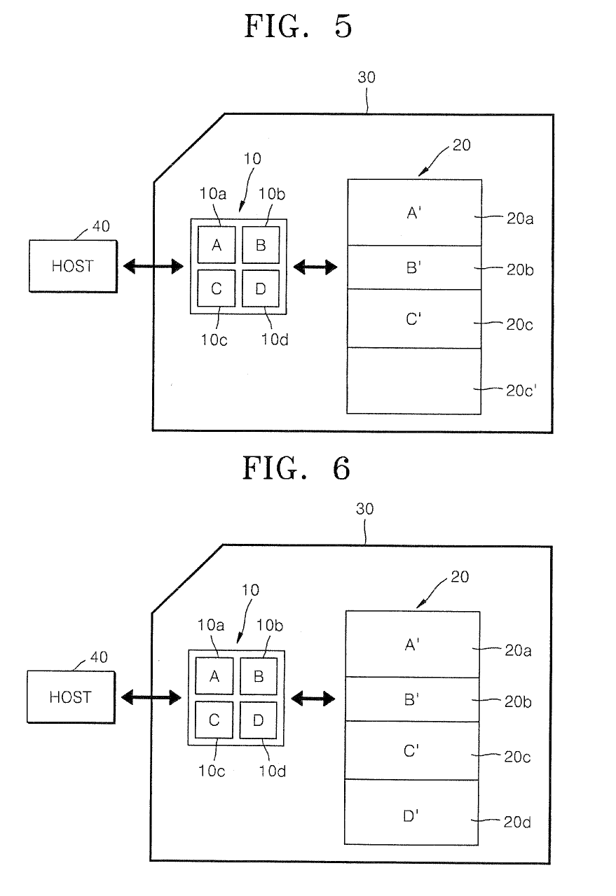

Referring to FIG. 5, a host device 40 may be a cellular phone manufactured by a third company and can be connected to the memory card 30. The controller 10 may store a third application program C. The memory 20 may have a storage region, which can store third data C′ associated with the third application program C. For example, the third data C′ may include file data of telephone numbers that are to be stored in the cellular phone manufactured by the third company. The third application program C may include a program for assigning a third region 20c, which is at least one part of the remaining region (20b′ of FIG. 4) excluding the first and second regions 20a and 20b of the storage region, in the format of the third data C′. The third data C′ may then be stored in the third region 20c. The format of the third data C′ may be different from the formats of the first and second data A′ or B′.

Referring to FIG. 6, a host device 40 may be a music reproducing apparatus manufactured by a fourth company and can be connected to the memory card 30. The controller 10 may store a fourth application program D. The memory 20 may have a storage region, which can store fourth data D′ associated with the fourth application program D. For example, the fourth data D′ may include data of MP3 music files that are to be stored in the music reproducing apparatus manufactured by the fourth company. The fourth application program D may include a program for assigning a fourth region 20d, which is at least one part of the remaining region (20c′ of FIG. 5) excluding the first, second, and third regions 20a, 20b, and 20c of the storage region, in the format of the fourth data D′. The fourth data D′ may then be stored in the fourth region 20d. The format of the fourth data D′ may be different from the formats of the first, second, and third data A′, B′, and C′. In this example embodiment, the controller 10 includes four application programs A, B, C, and D; however, a person with skill in the art will recognize that the present invention can be applied in a same or similar fashion to an arbitrary controller having one or more application programs.

According to another example embodiment of the present invention, a memory card may include a controller, which can selectively delete previously stored data. Also, an arbitrary storage region may be used, which is a part (for example, a part of the first region 20a, the second region 20b, the third region 20c, or the fourth region 20d) of a storage region in which data is previously stored, or which is a part of a storage region in which no data is stored. Data (for example, the first data A′ associated with the first application program A) may be added and updated to the arbitrary storage region in the appropriate format (for example, the format of data associated with the first application program A). In other words, the controller 10 can recollect first block data of the respective storage regions (for example, the storage regions 20a, 20b, 20c, and 20d of FIG. 6), assign an arbitrary storage region in a new data format, and then store the data in the new format in the arbitrary storage region.

Furthermore, the memory card may include a controller in which a plurality of application programs including a first application program and a second application program are stored. The memory card may also include a storage region in which first data regarding the first application program and second data regarding the second application program are stored. The first application program may assign a first region, which is at least one part of the storage region, in the format of the first data. The first application program may then store the first data in the first region. The second application program may assign a second region, which includes at least one part of the first region and/or at least one part of the remaining region, in the format of the second data, and storing the second data in the second region. Meanwhile, the first application program may further assign an arbitrary region of the storage region in the format of the first data, and may store the first data in the arbitrary region.

As described above, the memory cards according to the example embodiments of the present invention include a controller which can divide a storage region for storing data associated with one or more one application programs, into a plurality of sub storage regions. The plurality of sub storage regions may be respectively assigned in the formats of the data associated with one or more application programs, and can exist compatibly in the storage region. In other words, the formats of the corresponding data can co-exist in the same storage region, irrespective of the number of application programs and data types. The memory 20 may be a non-volatile memory, preferably, a flash memory.

According to various example embodiments of the present invention, the memory card may assign a region in which no data is stored, among storage regions of a memory, in the format of the corresponding data, wherein a single memory card can be used for a variety of application products. The memory card may use an application program stored in a controller, and may be configured to store data corresponding to the application program in the assigned region. This allows for a variety of applications, which can be made available through the use of a single memory card. For example, by storing key information in a memory card, the memory card can substitute for a car key, an office key, a house key, etc. At the same time, personnel health information may be stored in the same memory card such that the memory card can substitute for a medical treatment card.

As described above, according to embodiments the present invention, it is possible to apply a memory card to a variety of application products. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A memory card comprising:
a controller having an associated first memory structured to store at least two application programs; and
a second memory having a storage region structured to store data associated with the at least two application programs,
wherein the controller is configured to divide the storage region into a plurality of sub storage regions, each of the sub storage regions being associated with data from one of the two application programs.

2. The memory card of claim 1, wherein data associated with one of the sub storage regions has a different format than data associated with another one of the sub storage regions, each of the data formats co-existing in the second memory.

3. The memory card of claim 1, wherein the at least two application programs comprises a firmware program.

4. The memory card of claim 1, wherein the first memory comprises a Read Only Memory (ROM) configured to store the at least two application programs.

5. The memory card of claim 1, wherein the second memory is a non-volatile memory.

6. The memory card of claim 5, wherein the non-volatile memory is a flash memory.

7. A memory card comprising:
a controller having an associated first memory structured to store a plurality of application programs including a first application program and a second application program; and
a second memory having a storage region structured to store first data associated with the first application program and second data associated with the second application program,
wherein the first application program is configured to assign a first region in the format of the first data, the first region comprising at least one part of the storage region, and
wherein the second application program is configured to assign a second region in the format of the second data, the second region comprising at least one part of the remaining region excluding the first region.

8. The memory card of claim 7, wherein the first application program is configured to store the first data in the first region and the second application program is configured to store the second data in the second region.

9. The memory card of claim 7, wherein the format of the first data is different from the format of the second data.

10. The memory card of claim 7, wherein the second region comprises at least one part of the first region.

11. The memory card of claim 7, wherein the plurality of application programs further comprises a third application program and a fourth application program, the storage region being structured to store third data associated with the third application program and fourth data associated with the fourth application program.

12. The memory card of claim 11, wherein the third application program is configured to assign a third region in the format of the third data, the third region comprising at least one part of the storage region excluding the first region and the second region.

13. The memory card of claim 12, wherein the fourth application program is configured to assign a fourth region in the format of the fourth data, the fourth region comprising at least one part of the storage region excluding the first region, the second region, and the third region.

14. The memory card of claim 7, wherein each of the application programs is a firmware program, the first memory comprises a Read Only Memory (ROM) structured to store the plurality of application programs, and the second memory is a non-volatile memory.

15. The memory card of claim 7, wherein the first application program further comprises a program configured to assign an arbitrary region of the storage region in the format of the first data, and to store the first data in the arbitrary region.

16. A method for managing a storage region of a memory card comprising:
storing a plurality of application programs on a first memory associated with a controller, including a first application program and a second application program;
dividing a second memory, including the storage region, into a first sub storage region and a second sub storage region, the first sub storage region comprising a first data format and the second sub storage region comprising a second data format;
storing first data associated with the first application program in the first sub storage region; and
storing second data associated with the second application program in the second sub storage region.

17. The method of claim 16, wherein the second sub storage region comprises at least one part of the remaining storage region excluding the first sub storage region.

18. The method of claim 16, wherein the second sub storage region comprises at least one part of the first sub storage region.

19. The memory card of claim 16, wherein the second memory is a non-volatile memory.

20. The memory card of claim 19, wherein the non-volatile memory is a flash memory.
